(19) United States
(12) Patent Application Publication
(10) Pub. No.: US 2015/0035329 A1
(43) Pub. Date: Feb. 5, 2015

(54) SEAT WITH AUTOMATIC HARNESS STRAP ADJUSTMENT MECHANISM

(71) Applicant: Chad Allen Sparling, Ortonville, MI (US)

(72) Inventor: Chad Allen Sparling, Ortonville, MI (US)

(73) Assignee: RECARO CHILD SAFETY LLC, Auburn Hills, MI (US)

(21) Appl. No.: 14/297,857

(22) Filed: Jun. 6, 2014

Related U.S. Application Data
(60) Provisional application No. 61/860,022, filed on Jul. 30, 2013.

(51) Int. Cl. B60N 2/28; B60N 2/427

(52) U.S. Cl. CPC B60N 2/2884; B60N 2/42709; B60N 2/2839
USPC 297/216.11; 297/216.13

(57) ABSTRACT

A seating assembly is disclosed, and includes a seat, at least two harness straps, an adjustment mechanism, and at least one crush feature. The seat has a shell, and the shell has a rear surface. The harness straps each have upper portions. The adjustment mechanism adjusts the upper portions of each of the harness straps. The adjustment mechanism includes a rigid engagement member and at least one biasing member. The biasing member is configured to exert a biasing force upon the support member in an upwards direction to adjust the upper portions of the harness straps. The crush feature projects outwardly from the rear surface of the shell. The crush feature generally opposes the rigid engagement member. The rigid engagement member is configured to plastically deform the crush feature upon impact of a predetermined force.

### RELATED APPLICATIONS

This application claims the benefit of U.S. Provisional Application No. 61/860,022, filed on Jul. 30, 2013.

### BACKGROUND

The disclosure relates generally to a seat having harness straps and, more particularly, to an adjustment mechanism used for positioning the harness straps.

Child seats typically include two harness straps and a crotch strap, which are used to secure a child to the seat. Each of the harness straps is provided with a slidable tongue, and the crotch strap is provided with a buckle. The tongues of the harness straps are both selectively engaged by a latching mechanism located in the buckle of the crotch strap to secure the child to the seat. The harness straps include corresponding upper ends and lower ends, where the upper ends are typically received by slots located in a backrest of the seat, and the lower ends may be anchored to a seat pan. When the child is secured to the seat, the upper portion of both the harness straps should be positioned at or slightly below the child's shoulders. Various types of adjustment mechanisms currently exist that automatically position the upper portions of the harness straps relative to the child's shoulders. However, there exists a continuing need for a child seat that includes an improved adjustment mechanism for automatically positioning the harness straps.

### SUMMARY

In one embodiment, a seating assembly is disclosed, and may include a seat, at least two harness straps, an adjustment mechanism, and at least one crush feature. The seat may have a shell, and the shell may have a rear surface. The harness straps may each have upper portions. The adjustment mechanism may adjust the upper portions of each of the harness straps. The adjustment mechanism may include a rigid engagement member and at least one biasing member. The biasing member may be configured to exert a biasing force upon the support member in an upwards direction to adjust the upper portions of the harness straps. The crush feature may project outwardly from the rear surface of the shell. The crush feature may generally oppose the rigid engagement member. The rigid engagement member may be configured to plastically deform the crush feature upon impact of a predetermined force.

In another embodiment, a seating assembly for securing a child or infant is disclosed, and may include a seat, at least two harness straps, an adjustment mechanism, and at least one crush rib positioned along each opposing side of the seat. The seat may have a shell. The shell may have a rear surface. The harness straps may each have upper portions. The adjustment mechanism may adjust the upper portions of each of the harness straps. The adjustment mechanism may include a rigid engagement member and at least one biasing member. The biasing member may be configured to exert a biasing force upon the support member in an upwards direction to adjust the upper portions of the harness straps. The crush ribs may project outwardly from the rear surface of the shell. The crush ribs may generally oppose the rigid engagement member. The rigid engagement member may be configured to plastically deform the crush ribs upon impact of a predetermined force.

Other objects and advantages of the disclosed method and system will be apparent from the following description, the accompanying drawings and the appended claims.

### BRIEF DESCRIPTION OF THE DRAWINGS

FIG. 1 is a front view of the disclosed child seat assembly;

FIG. 2 is a front view of the seat shown in FIG. 1, where a seat cover is removed;

FIG. 3 is a perspective of the rear of the seat of FIG. 1, where harness straps are omitted;

FIG. 4 is a perspective of a headrest shown in FIG. 1;

FIGS. 5 and 6 are views taken along line 5-5 in FIG. 3, where FIG. 5 is an illustration of a crush rib before vehicle impact, and FIG. 6 is an illustration of the crush rib after vehicle impact;

FIG. 7 is a rear detail of the seat shown in FIG. 1; and

FIG. 8 is an illustration of a bottom surface of the seat shown in FIG. 1.

### DETAILED DESCRIPTION

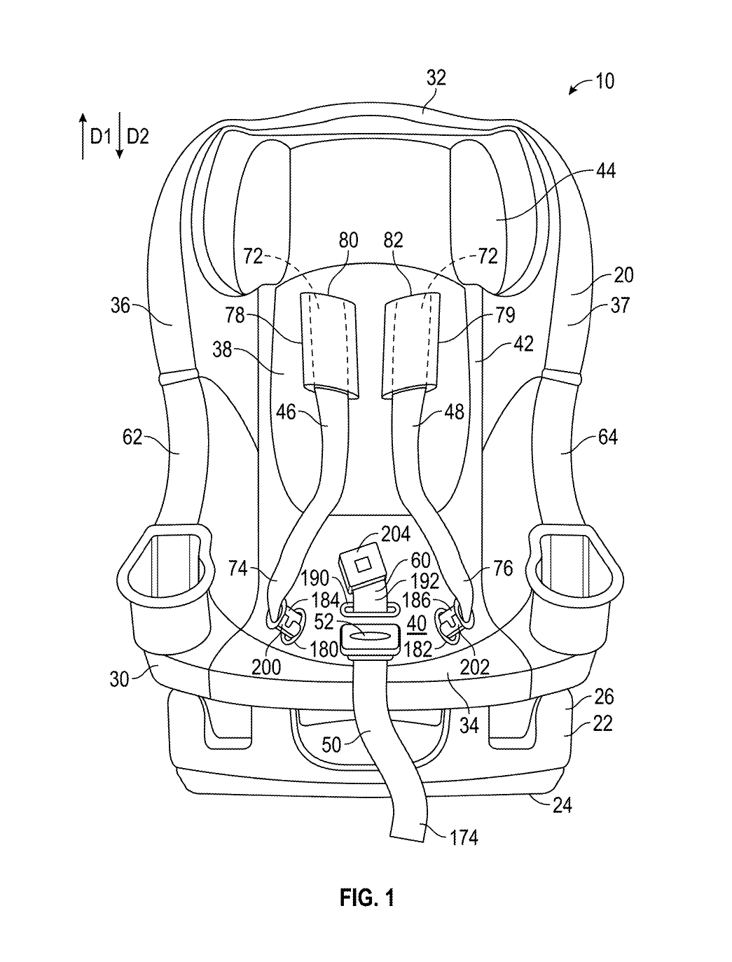

As shown in FIG. 1, the disclosed child seat assembly, generally designated 10, may include a seat 20 and a base 22. The base 22 may include a lower surface 24 and an upper portion 26. The base 22 may be adapted to be installed on a vehicle seat (not illustrated), where the lower surface 24 of the base 22 rests against the vehicle seat. The upper portion 26 of the base 22 may selectively receive a bottom portion 30 of the seat 20.

The seat 20 may have a head end 32, a foot end 34, two opposing sides 36, 37, a back support 38, and a seat pan 40. The two sides 36, 37 of the seat 20 may be generally parallel with one another and extend between the head end 32 and the foot end 34. The seat 20 may also include a cover 42, a headrest 44, two harness straps 46, 48, an adjuster strap 50, a web adjuster 52, a crotch strap 60, and two arm rests 62, 64. The headrest 44 may be located at the head end 32 of the seat 20. The headrest 44 may be moveable in an upward direction Dl towards the head end 32 of the seat, and a downward direction D2 towards the bottom portion 30 of the seat 20. The armrest 62 may be located along the side 36 and the armrest 64 may be located along the side 37 of the seat 20. The crotch strap 60 may be located on the seat pan 40 of the seat 20. Although the seat 20 is illustrated as a child seat received by the base 20, it is to be understood that the base 22 may be omitted in another embodiment. In one embodiment, the seat 20 may be any type of child seat configured to secure a child or an infant in a vehicle such as, for example, an infant seat, a convertible seat, or a combination seat. However, it is to be understood that the seat 20 is not limited to child seating used in a vehicle, and may be used in any type of juvenile product such as, for example, a booster seat or a high chair seat. Moreover, in an alternative embodiment, the seat 20 may be configured to secure an adult, such as a passenger seat in a motor vehicle or an aircraft.

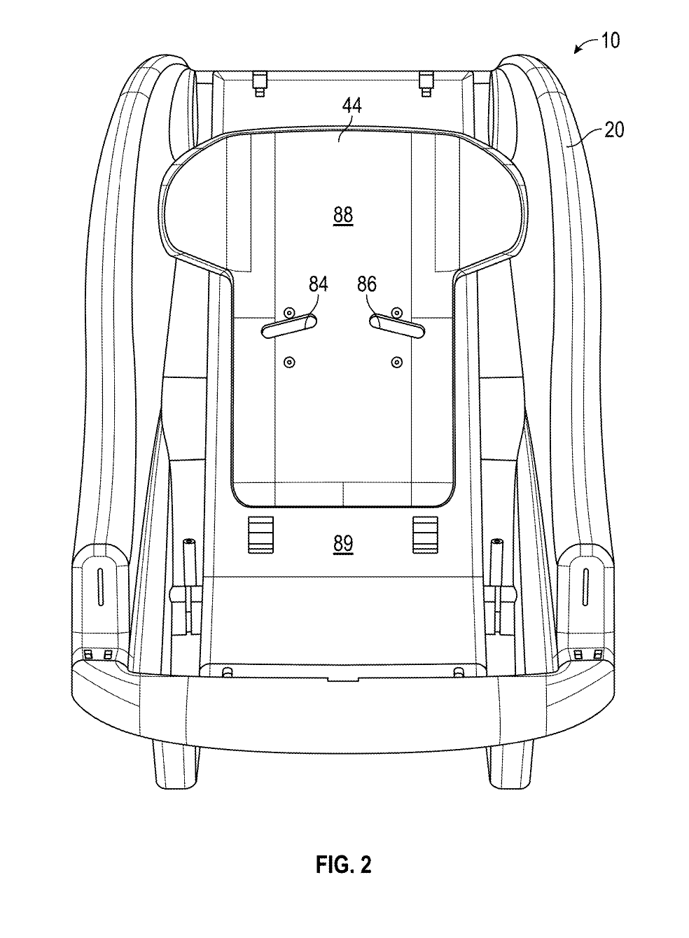

The harness straps 46, 48 may include corresponding upper portions 70, 72 (shown in phantom line) and corresponding lower portions 74, 76. The upper portions 70, 72 of the harness straps 46, 48 may be received by corresponding tubular pads 78, 79 located along the back support 38. The upper portions 70, 72 of the harness straps 46, 48 may each pass through respective slits 80, 82 located in the seat cover 42 on the back support 38. Referring to FIG. 2, the cover 42 of the seat 20 has been removed, thereby revealing a shell 88 of the headrest 44 and a shell 89 of the seat 20. The shell 88 may have two openings 84, 86 that correspond to one of the slits 80, 82 in the seat cover 42 (shown in FIG. 1). Referring to FIGS. 1-2, the upper portions 70, 72 of the harness straps 46, 48 may also pass through the respective openings 84, 86 located in the headrest 44.

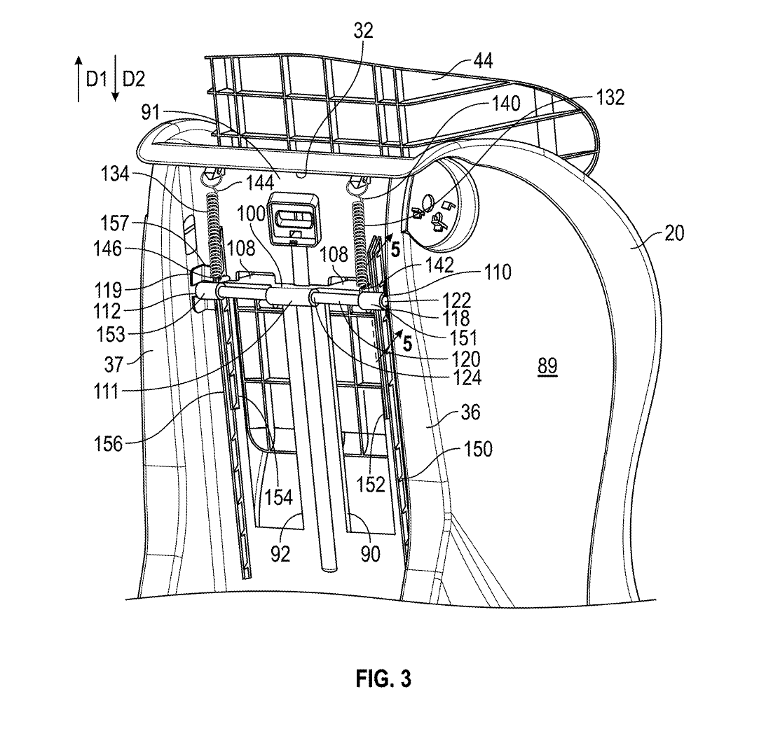

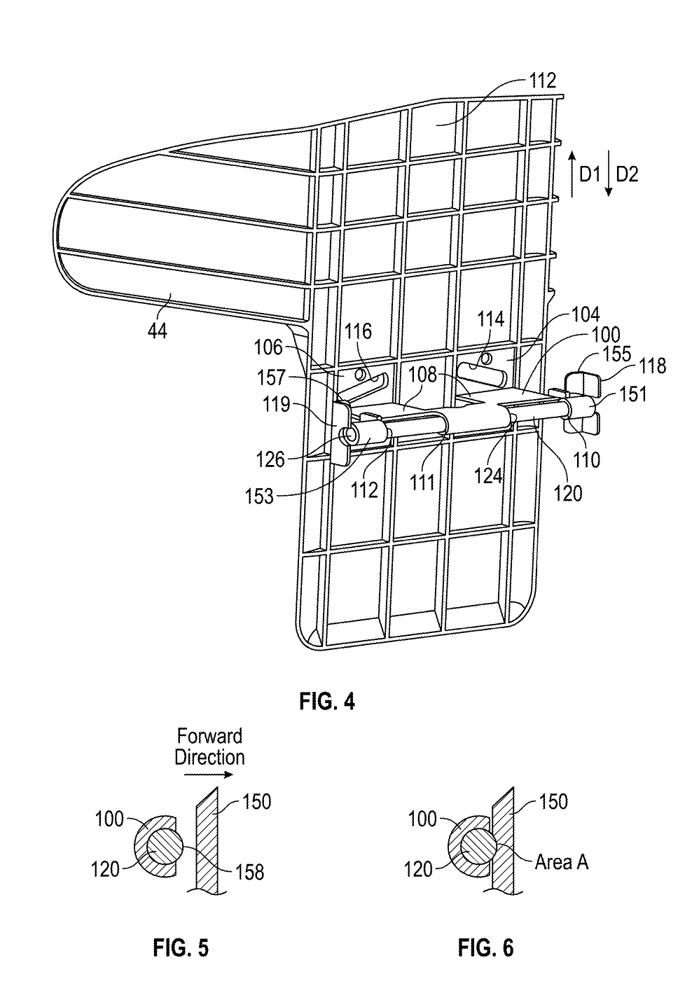

Referring to FIGS. 1 and 3, a rear surface 91 of the seat 20 may have two vertically extending slots 90, 92 that correspond to the openings 84, 86 in the shell 88 of the headrest 44. The two upper portions 70, 72 of the harness straps 46, 48 (shown in FIG. 1) may pass through the two slots 90, 92 in the seat 20. Referring to both FIGS. 3-4, a support member 100 may be connected to the headrest 44. The support member 100 may include two flange portions 104, 106, a connection portion 108, discrete sleeve portions 110, 111, 112, and end members 118, 119. The flange portions 104, 106 of the sleeve 100 may be attached to a rear surface 112 of the headrest 44. Thus, as the headrest 44 moves in the upward direction D1 and the downward direction D2, the support member 100 may move in concert along with the headrest 44. The support member 100 may include slots 114, 116 that correspond to the slots 84, 86 located in the headrest 44 (shown in FIG. 2), where the slot 114 may be located on the flange portion 104 and the slot 116 may be located on the flange portion 106. The two upper portions 70, 72 of the harness straps 46, 48 (shown in FIG. 1) may pass through the two slots 114, 116 of the support member 100.

The connection portion 108 may connect the two flange portions 104, 106 to the sleeve portions 110, 111, 112 of the support member 100. The sleeve portions 110, 111, and 112 may each be configured to receive and secure a portion of a rod 120. Specifically, the sleeve portion 110 of the support member 100 may be located adjacent the side 36 of the seat 20 (shown in FIG. 3), and the sleeve portion 112 may be located adjacent the side 37 of the seat 20. The sleeve portion 111 may be located between the sleeve portions 110 and 112. The sleeve portion 110 of the support member 100 may be configured to receive an end 122 of the rod 120 (shown in FIG. 3), the sleeve portion 111 may be configured to receive a central portion 124 of the rod 120, and the sleeve portion 112 may be configured to receive an end 126 of the rod 120 (shown in FIG. 4).

Referring to FIG. 3, two biasing members or springs 132, 134 may be mounted to the seat 20 and the support member 100. Specifically, the spring 132 may be located adjacent the side 36 of the seat 20, and may include a first end 140 attached to the head end 32 of the seat 20 and a second end 142 attached to the sleeve portion 110 of the support member 100. The spring 134 may be located adjacent the side 37 of the seat 20, and may include a first end 144 attached to the head end 32 of the seat 20 and a second end 146 attached to the sleeve 112 of the support member 100. The springs 132, 134 may exert a biasing force on the support member 100 in a generally upwards direction (e.g., in the upward direction Dl), which is discussed in greater detail below. The headrest 44, the support member 100, the rod 120 and the springs 132, 134 define an adjustment mechanism, which may be used to position the harness straps 46, 48 at or below the child's shoulders, and is also described in greater detail below.

The rear surface 91 of the seat 20 may also include at least one crush feature that projects from the seat 20. Specifically, in the non-limiting embodiment as shown in FIG. 3, the crush feature is a plurality of generally vertical crush ribs 150, 152, 154, and 156 that project outwardly from the rear surface 91 of the seat 20. The crush ribs 150, 152 may be located adjacent the side 36 of the seat 20, and crush ribs 154, 156 may be located adjacent the side 37 of the seat 20. The crush ribs 150, 152, 154, and 156 may be constructed of the same material as the shell 89 of the seat 20, which is typically a plastic material. The crush ribs 150 and 156 extend further downwardly along the rear surface 91 of the seat 20 when compared to the crush ribs 152, 154, and is discussed in greater detail below. Those skilled in the art will appreciate that although four crush ribs 150, 152, 154, and 156 are illustrated, the rear surface 91 of the seat 20 may include any number of crush ribs depending on the requirements of a specific application.

Referring to both FIGS. 3-4, the end members 118, 119 of the support member 100 may be used to ensure generally linear motion of the headrest 44 in the upward direction D1 and the downward direction D2. The end members 118, 119 may be located on opposing ends 151, 153 of the support member 100. The end member 118 may include a flange 155 (seen in FIG. 4) that is positioned adjacent the crush rib 150, and the end member 119 may include a flange 157 (best seen in FIG. 3) that is positioned adjacent the crush rib 156. If the support member 100 starts to shift in a direction generally transverse to the crush rib 150, the flange 155 of end member 118 may abut against the crush rib 150, thereby re-directing motion of the support member 100 in a linear direction. Likewise, if the support member 100 starts to shift in a direction generally transverse to the crush rib 156, the flange 157 if end member 119 may abut against the crush rib 156, thereby re-directing motion of the support member 100 in a linear direction. The abutment between the end members 118, 119 and their respective crush ribs 150, 156 may generally ensure that the support member 100 may not shift or move while the support member 100 travels in the upward direction D1 or the downward direction D2. Since the support member 100 is connected to the headrest 44, generally linear movement of the support member 100 translates into generally linear movement of the headrest 44 as well.

FIG. 5 illustrates an outer surface 158 of the rod 120 generally opposing the crush rib 150. In the event of vehicle impact, the rod 120 may be urged in the forward direction, towards the crush rib 150. Specifically, as seen in FIG. 6, the rod 120 impacts and plastically deforms into the crush rib 150 at Area A. Thus, the rod 120 may now be embedded in the crush rib 120 at Area A. This ensures that the rod 120 may not generally slide or shift in the vertical direction during vehicle impact (i.e., the rod 120 may not generally slide in either the upward direction Dl or the downward direction D2). The rod 120 may be a generally rigid engagement member constructed of a high-strength material capable of plastically deforming the material of the crush rib 150. For example, in one embodiment the rod 120 is constructed of metal. It should be noted that while FIGS. 5-6 illustrate only crush rib 150, the rod 120 may also impact the remaining crush ribs 152, 154, and 156 as well, and is discussed in greater detail below. Moreover, it should also be noted that while FIG. 3 illustrates a total of four crush ribs located adjacent the sides 36, 37 of the seat 20, it is to be understood that one or more crush ribs may also extend along a central portion of the seat 20 as well.

Although crush ribs 150, 152, 154, and 156 are illustrated in the figures, those skilled in the art will readily appreciate that any feature for absorbing energy and ensuring that the rod 120 may not generally slide or shift in the vertical direction during vehicle impact may be used as well. For example, in one embodiment, a vertical strip of an elastomeric material such as rubber may be placed along the rear surface 91 of the seat 20, and is used to generally prevent the rod 120 from sliding in the vertical direction during vehicle impact. In another embodiment, a vertical strip of foam or another type of compressible material may be placed along the rear surface 91 of the seat 20 to generally prevent the rod 120 from sliding in the vertical direction during vehicle impact. One example of the foam that may be used is expanded polypropylene (EPP).

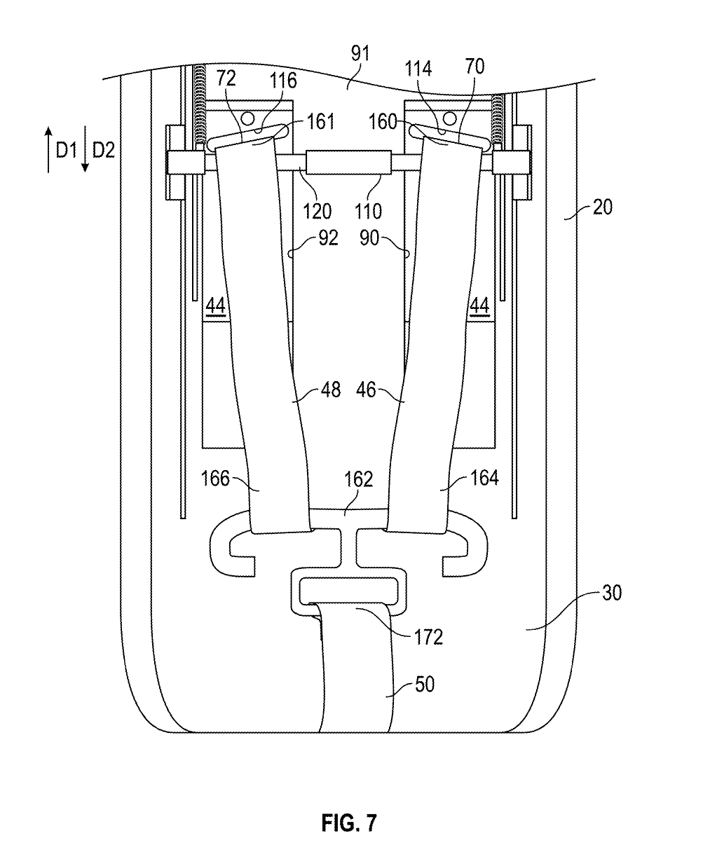

FIG. 7 is an illustration of the rear surface 91 of the seat 20. The upper portions 70, 72 of the harness straps 46, 48 may pass through the slots 114, 116 in the support member 100. A portion of each of the harness straps 46, 48 may rest against the rod 120. Specifically, a portion 160 of the harness strap 46 may rest against the rod 120, and a portion 161 of the harness strap 48 may rest against the rod 120. The harness straps 46, 48 may extend in a generally downward direction from the rod 120 towards the bottom portion 30 of the seat 20. A t-bar 162 may be located along the bottom portion 30 of the seat 20. Both of the harness straps 46, 48 may be secured to the t-bar 162 at their respective ends. Specifically, a first end 164 of the harness strap 46 and a first end 166 of the harness strap 48 may both be received and secured to the t-bar 162. The t-bar 162 also may receive and secure a first end 172 of the adjuster strap 50. The t-bar 162 may be used to connect the harness straps 46, 48 to the adjuster strap 50. Although a t-bar is shown in FIG. 7, it is understood that any type of securing device may be used to receive and secure the harness straps 46, 48 to the adjuster strap 50.

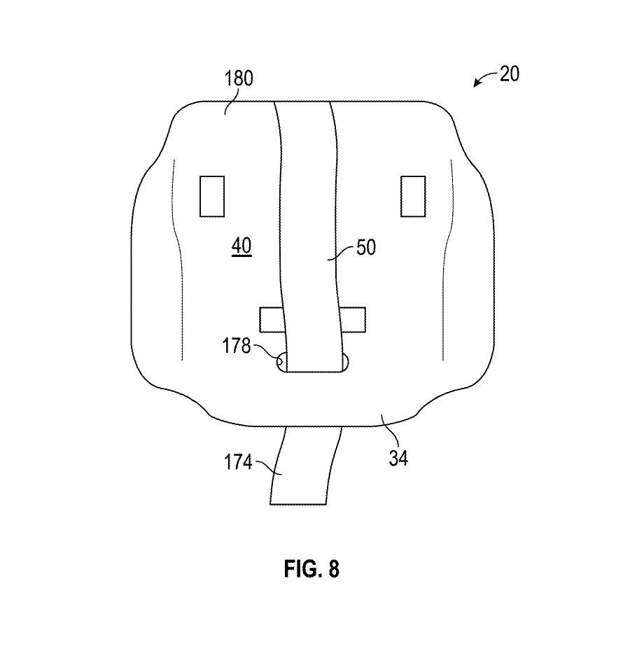

FIG. 8 is an illustration of a bottom surface 180 of the seat 20, along the seat pan 40. The adjuster strap 50 may extend along the bottom surface 180 towards the foot end 34 of the seat 20. A second end 174 of the adjuster strap 50 may pass through an opening 178 located at the foot end 34 of the seat 20, and may be received through the web adjuster 52 (shown in FIG. 1). Operation of the web adjuster 52 allows the adjuster strap 50 to be loosened or tightened, which in turn results in the loosening or tightening of the harness straps 46, 48.

Referring back to FIG. 1, the lower portions 74, 76 of the harness straps 46, 48 may each be received by respective openings 180, 182 located along the seat cover 42 at the seat pan 40. A second end 184 of the harness strap 46 and a second end 186 of the harness strap 48 may both be fixedly attached to the shell 89 of the seat 20 (shown in FIG. 3). The crotch strap 60 may also be received by an opening 190 located along the of the seat cover 42 at the seat pan 40. An end 192 (shown in FIG. 5) of the crotch strap 60 may be fixedly attached to the shell 89 of the seat 20 (shown in FIG. 3). The harness straps 46, 48 may each include respective buckle tongues 200, 202. The buckle tongues 200, 202 may be slidably mounted on one of the harness straps 46, 48. The crotch strap 60 may include a buckle 204 that selectively engages both the buckle tongues 200, 202.

Once a child is placed in the seat 20, the harness straps 46, 48 may be positioned over the arms and shoulders of the child. Referring to FIGS. 1 and 7-8, the second end 174 of the adjuster strap 50 may then be pulled through the web adjuster 52. Pulling the adjuster strap 50 through the web adjuster 52 may in turn pull the harness straps 46, 46 taut, thus positioning the upper portions 70, 72 of the harness straps 46, 48 at or below the child's shoulders. Referring specifically to FIG. 7, the adjuster strap 50 may be urged in the downward direction D2 when the second end 174 of the adjuster strap 50 is pulled. The harness straps 46, 48, which are connected to the adjuster strap 50 by the t-bar 162, may also be urged in the downward direction D2, and eventually pulled taut. Continuing to pull on the second end 174 of the adjuster strap 50 once the harness straps 46, 48 are taut causes the upper portions 70, 72 of the harness straps 46, 48 to exert a downward force on the support member 100 and the headrest 44. The downward force may urge the headrest 44 and the support member 100 in the downward direction D2. As the headrest 44 and the support member 100 are urged in the downward direction D2, the springs 132, 134 may expand.

The second end 174 of the adjuster strap 50 may continue to be pulled, thereby causing the headrest 44 to move in the downward direction D2 until the upper portions 70, 72 of the harness straps 46, 48 abut against the child's shoulders. Once the upper portions 70, 72 of the harness straps 46, 48 abut against a child's shoulders, the web adjuster 52 may engage the adjuster strap 50 in order to secure the adjuster strap 50 in place. When the adjuster strap 50 is secured by the web adjuster 52, the support member 100 may be held in a stationary position, and the headrest 44 may be substantially unable to move in the upward direction Dl or the downward direction D2. The buckle tongues 200, 202 of the harness straps 46, 48 may then be engaged with the buckle 204 of the crotch strap 60, which secures the child in the seat.

Referring to FIGS. 4-6, in the event of vehicle impact while the child is secured to the seat 20, the rod 120 may be urged in the forward direction, and impacts and plastically deforms into at least some of the crush ribs 150, 152, 154, and 156. Specifically, the rod 120 impacts one or more of the crush ribs 150, 152, 154, and 156 with a predetermined force sufficient to plastically deform one or more of the crush ribs. Both the rod 120 and the support member 100 (which receives the rod 120) may not generally slide or shift in the vertical direction during vehicle impact. Thus, because the upper portions 70, 72 of the harness straps 46, 48 (FIG. 1) may be secured to the support member 100 (i.e., by passing through the slots 114, 116 located in the support member 100), both of the harness straps 46, 48 may also be unable to slide or shift in the vertical direction during vehicle impact as well.

Referring specifically to FIG. 3, it should be noted that crush ribs 150 and 156 may extend further downwardly along the rear surface 91 of the seat 20 when compared to the crush ribs 152 and 154. This is because the crush ribs 152 and 154 may be designated to engage with the rod 120 if a larger child is placed in the seat 20. Specifically, when a larger child is placed in the seat 30, the harness straps 46, 48 (FIG. 1) may be positioned further upwardly towards the head end 32 of the seat 20. This in turn causes the rod 120 to also be positioned further upwardly toward the head end 32 of the seat 20. Thus, each of crush ribs 150, 152, 154, and 156 may oppose the outer surface 158 (FIGS. 5-6) of the rod 120. Likewise, if a smaller child is placed in the seat 20, the harness straps 46, 48 (FIG. 1) may be positioned further downwardly towards the foot end 34 of the seat 20 (shown in FIG. 1). This in turn causes the rod 120 to also be positioned further downwardly toward the foot end 34 of the seat 20. Thus, only crush ribs 150 and 156 may oppose the outer surface 158 (FIGS. 5-6) of the rod 120.

When a larger child is placed in the seat, more reinforcement may be needed to keep the support member 100 and the rod 120 from shifting or sliding in the vertical direction during vehicle impact. Thus, the rod 120 may engage and plastically deform all of the ribs 150, 152, 154, and 156. Likewise, a smaller child may require less reinforcement to keep the support member 100 and the rod 120 from shifting in the vertical direction during vehicle impact. Thus, the rod 120 may engage and plastically deform only ribs 150 and 156.

Referring to FIGS. 1, 3, and 7, in order to remove a child from the seat 20, the buckle tongues 200, 202 of the harness straps 46, 48 may be disengaged from the buckle 204 (shown in FIG. 1). The web adjuster 52 may then be disengaged from the adjuster strap 50. Thus, the support member 100 may no longer be held in the stationary position. The springs 132, 134 (FIG. 3) may now contract, and exert the biasing force on the support member 100 in the generally upwards direction D1. This in turn urges the support member 100 and the headrest 44 in the upwards direction D1. As the headrest 44 and the support member 100 move in the upwards direction D1, the harness straps 46, 48 may also be moved away from the child's shoulders. The child may now be removed from the seat 20.

Referring generally to the figures, the disclosed crush ribs are provided in an effort to substantially prevent the harness straps of the seating assembly from sliding or shifting in the vertical direction during vehicle impact. Some other types of seating assemblies currently available do not have any mechanism for securing the harness straps in place during vehicle impact. As a result, these types of seating assemblies may not generally be suitable for use as a forward-facing seat in a vehicle. In contrast, the disclosed crush ribs are provided to substantially prevent the harness straps of the seating assembly from shifting during impact. Thus, the disclosed seating assembly may be appropriate for use as a forward-facing seat in a vehicle.

While the forms of apparatus and methods herein described constitute preferred aspects of this disclosure, it is to be understood that the disclosure is not limited to these precise forms of apparatus and methods, and the changes may be made therein without departing from the scope of the disclosure.

What is claimed is:

1. A seating assembly, comprising:
a seat having a shell, the shell having a rear surface;
at least two harness straps each having upper portions;
an adjustment mechanism for adjusting the upper portions of each of the harness straps, the adjustment mechanism including a rigid engagement member and at least one biasing member, wherein the biasing member is configured to exert a biasing force upon the support member in an upwards direction to adjust the upper portions of the harness straps; and
at least one crush feature projecting outwardly from the rear surface of the shell, wherein the crush feature generally opposes the rigid engagement member, and the rigid engagement member is configured to plastically deform the crush feature upon impact of a predetermined force.

2. The seating assembly of claim 1, wherein the seat includes two opposing sides, and wherein the at least one crush feature is at least one crush rib that is positioned along each of the two opposing sides of the seat.

3. The seating assembly of claim 2, wherein a plurality of crush ribs are positioned along each of the two opposing sides of the seat.

4. The seating assembly of claim 3, wherein a portion of the plurality of crush ribs positioned along each of the two opposing sides of the seat extend further downwardly along the rear surface of the seat compared to a remaining portion of the plurality of crush ribs.

5. The seating assembly of claim 1, wherein the crush feature is constructed of an elastomeric material, plastic, or foam.

6. The seating assembly of claim 1, further comprising an adjuster strap and a web adjuster, wherein the harness straps are connected to the adjuster strap, and the adjuster strap is selectively secured by the web adjuster.

7. The seating assembly of claim 6, wherein the seat further includes a headrest, and wherein the headrest is configured to move in the upwards direction and a downwards direction.

8. The seating assembly of claim 7, wherein if the adjuster strap is secured by the web adjuster, the headrest is substantially unable to move in the upwards direction and the downwards direction.

9. The seating assembly of claim 7, further comprising a support member connected to the headrest, wherein the support member is configured to receive and secure a portion of the rigid engagement member.

10. The seating assembly of claim 1, wherein the seating assembly is one of an infant seat, a convertible seat, a combination seat, a booster seat, and a high chair.

11. The seating assembly of claim 1, wherein the seating assembly is a passenger seat in a motor vehicle or an aircraft.

12. The seating assembly of claim 1, wherein the generally rigid member is constructed of metal.

13. A seating assembly for securing a child or infant, comprising:
a seat having two opposing sides and a shell, the shell having a rear surface;
at least two harness straps each having upper portions;
an adjustment mechanism for adjusting the upper portions of each of the harness straps, the adjustment mechanism including a rigid engagement member and at least one biasing member, wherein the biasing member is configured to exert a biasing force upon the support member in an upwards direction; and
at least one crush rib positioned along each of the two opposing sides of the seat, wherein the crush ribs project outwardly from the rear surface of the shell, and wherein the crush ribs generally oppose the rigid engagement member, and the rigid engagement member is configured to plastically deform the crush ribs upon impact of a predetermined force.

14. The seating assembly of claim 13, wherein a plurality of crush ribs extend along the two opposing sides of the seat, and wherein a portion of the plurality of crush ribs positioned along each of the two opposing sides of the seat extend further downwardly along the rear surface of the seat compared to a remaining portion of the plurality of crush ribs.

15. The seating assembly of claim 13, wherein the crush rib is constructed of the same material as the shell of the seat.

16. The seating assembly of claim 13, further comprising an adjuster strap and a web adjuster, wherein the harness straps are connected to the adjuster strap, and the adjuster strap is selectively secured by the web adjuster.

17. The seating assembly of claim 16, wherein the seat further includes a headrest, and wherein the headrest is configured to move in the upwards direction and a downwards direction.

18. The seating assembly of claim 17, wherein if the adjuster strap is secured by the web adjuster, the headrest is substantially unable to move in the upwards direction and the downwards direction.

19. The seating assembly of claim 17, further comprising a support member connected to the headrest, wherein the support member is configured to receive and secure a portion of the rigid engagement member.

20. The seating assembly of claim 13, wherein the generally rigid member is constructed of metal.
